(19) United States
(12) Patent Application Publication
(10) Pub. No.: US 2011/0114214 A1
(43) Pub. Date: May 19, 2011

(54) REINFORCED HOSE

(75) Inventor: Andreas Flachenecker, Essen (DE)

(73) Assignee: POLYAMIDE HIGH PERFORMANCE GMBH

(21) Appl. No.: 12/812,616

(22) PCT Filed: Dec. 18, 2008
(86) PCT No.: PCT/EP2008/067835

§ 371 Date: Dec. 7, 2010

(30) Foreign Application Priority Data
Jan. 23, 2008 (EP) PCT/EP2008/000481
Aug. 19, 2008 (EP) 08162622.8

(51) Int. Cl. F16L 11/00; B29C 63/10

(52) U.S. Cl. 138/118; 156/187

(57) ABSTRACT

A hose made from an elastomeric material and a textile reinforcement. The textile reinforcement is made substantially of fibers selected from aliphatic polyamides having a heat shrinkage smaller than 2.5%. Also, a method for producing a hose having a textile reinforcement. The method includes extruding a hose from an elastomer material, applying a textile reinforcement to the outer circumference of the extruded hose, extruding an elastomer covering onto the textile reinforcement, and then vulcanizing the hose.

The invention relates to hoses composed of an elastomer material and comprising a textile reinforcement, and deals in particular with a textile reinforcement based on polyamide fibers.

Hoses of this type are suitable in particular for use in cooling systems. Cooling systems in modern water-cooled or liquid-cooled vehicle engines have reinforced hoses composed of flexible materials through which the fluids circulate both to and from the radiator.

Document DE 2 063 641 discloses a reinforced hose that is preferably reinforced by a single layer of a treated polyester or nylon fabric.

Currently, aramid fibers are also being utilized for this application. At increased coolant operating temperatures, however, hose reinforcements composed of polyester fibers or aramid fibers have only a low resistance to hydrolysis.

However, effective resistance to hydrolysis is required in order to produce relatively thin-walled hoses since in these hoses water diffuses more readily up to the reinforcement material and can reduce the stability of the reinforcement.

Compared to aramid or polyester, hoses comprising a textile reinforcement based on fibers composed of aliphatic polyamide provide improved resistance to hydrolysis. However, these hoses comprising a textile reinforcement based on aliphatic polyamide fibers have an uneven or nonuniform surface.

Included in the group of aliphatic polyamides, for example, are polymers that are known to the person skilled in the art under the name nylon, among which in particular are polyamide 6, polyamide 6.6, or also polyamide 4.6.

The object of this invention is thus to provide a hose comprising a textile reinforcement in which the disadvantages of the prior art are at least reduced. In particular, the hose should have good resistance to hydrolysis and at the same time have a smoother, more uniform surface.

This object is achieved by a hose comprising an elastomer material and a textile reinforcement, wherein the textile reinforcement is composed essentially of fibers, selected from the group of aliphatic polyamides, characterized in that the hot-air shrinkage of the fibers utilized is less than 2.5%, as determined according to DIN 53866 at 180° C., 2 min, and a preload of 5 mN/tex.

The term fiber comprises linear structures composed of one or more filaments, where the filaments may exists as continuous or staple fibers. Linear formations composed of continuous filaments are also referred to as multifilament yarns, while linear structures composed of a continuous filament are referred to as monofilament yarns.

Textile reinforcements which are composed essentially of fibers selected from the group of aliphatic polyamides are understood to include those textile reinforcements that are composed at least predominantly of fibers selected from the group of aliphatic polyamides. The textile reinforcement is preferably composed of fibers at a level of at least 60% by weight, selected from the group of aliphatic polyamides. In addition, those textile reinforcements are preferred that are composed at a level of at least 70% by weight, at least 80% by weight, and especially preferably at least 90% by weight of fibers, selected from the group of aliphatic polyamides. The textile reinforcement can of course also be composed at a level of 100% by weight of fibers, selected from the group of aliphatic polyamides.

The group of elastomer materials includes synthetic and natural polymers that are characterized in that they can elongate and bend in response to a slight exertion of force, and be restored, that is, return to their original shape, without the action of a force. One suitable material for a reinforced hose according to this invention is rubber. Rubber within the scope of the invention includes natural or synthetic rubber that is vulcanized. Synthetic rubber is generally composed of styrene and butadiene; other base raw materials are styrene acrylate, pure acrylate, vinyl acetate. Examples of suitable elastomer materials are styrene-butadiene rubber, neoprene, EPDM (ethylene-propylene-diene rubber), ethylene-propylene-terpolymer rubber, nitrile butadiene rubber, or hydrogenated nitrile butadiene rubber.

The production of hoses according to the invention significantly reduces any cutting of the fibers into the interior of the hose tube and the formation of an uneven pebbled surface on the exterior of the hose tube.

Although this result can be achieved with selected polyester or aramid yarns, it is not feasible even when using conventional low-shrinkage nylon yarns. Low-shrinkage yarns familiar to the person skilled in the art, in particular, nylon 6.6 multifilament yarns, exhibit a hot-air shrinkage of at least 2.5% up to approximately 3.5%., as measured according to DIN 53866 at 180° C., 2 min, and a preload of 5 mN/tex. The formation of an uneven, pebbled surface of the exterior of the hose tube cannot be avoided when using these low-shrinkage yarns. The fibers of the textile reinforcement of the hose according to the invention possess the required properties even before the hose is produced, i.e., before vulcanization.

In the hose according to this invention, the fibers of the textile reinforcement, which is essentially composed of aliphatic polyamides, preferably has a hot-air shrinkage, as determined according to DIN 53866 at 180° C., 2 min, and a preload of 5 mN/tex, of less than 2.3%.

Especially preferred are fibers selected from the group of aliphatic polyamides that have a hot-air shrinkage, as determined according to DIN 53866 at 180° C., 2 min, and a preload of 5 mN/tex of less than 2.1%.

The aliphatic polyamides, of which the fibers of the textile reinforcement are essentially composed, are preferably polyamide 6, polyamide 6.6, polyamide 4.6, or mixtures of these polymers.

The fibers of the textile reinforcement are preferably provided as multifilament yarn. The linear density range for multifilament yarns is preferably between 350 dtex and 2500 dtex, especially preferably between 700 dtex and 2100 dtex. The filament count of the multifilament yarn preferably ranges between 70 and 280 filaments.

It is also possible to utilize constructions composed of multifilament yarns, preferably of between 1 and 3 multifilament yarns, having a total linear density of up to 3000 dtex, such as, for example, 940 dtex×3, 700 dtex×3, 940 dtex×2, 1880×1, 2100×1, and 1400×1. These yarn constructions can be provided with twists at between 40 and 200 twists per meter. As a result, not only the cohesion of the yarns but also their resistance to fatigue is enhanced.

The yarns for the textile reinforcement are produced, by way of example, by spinning the heated and melted polymer material.

The spun yarn can then be wetted with a finishing agent and drawn as required, with the result that in the mean time yarn strengths can be achieved measuring 660 mN/tex up to 970 mN/tex and breaking elongations of 16% to 28%. The yarns thus drawn are then relaxed by subsequently applying heat, and optionally moisture.

The humidity range here can be between 60-100% in hot steam. Alternatively, the yarns can also be wetted completely with hot water.

When undergoing the treatment with hot water, the water is preferably made to flow around the yarn in a reactor, the hot water initially being at 70° C. The water is then heated continuously to a final temperature of between 80° C. and 140° C. (heating rate of 1° C./min), and maintained there for 10 to 40 minutes. The yarn is then cooled by washing with water at room temperature and dried.

In the steam treatment, the yarn is passed through tanks that are filled with steam at ambient pressure. The temperature of the steam preferably ranges between 240° C. and 285° C. The hot steam initiates the shrinkage. After the steam treatment, the yarn is rewound in ambient air. What is achieved by these preferred treatments is that the hot-air shrinkage ranges between 1.3% and 2.5%, preferably, between 1.3% and 2.3%, as determined by DIN 53866 at 180° C., 2 min, and a preload of 5 mN/tex.

Instead of drawing the spun yarn and subsequently treating it with hot water or steam, the spun yarn after spinning can also directly undergo treatment with steam and simultaneous drawing. After subsequent relaxation, the required hot-air shrinkage of between 1.3% and 2.5% is achieved, as determined according to DIN 53866 at 180° C., 2 min, and a preload of 5 mN/tex.

The fibers of the textile reinforcement can also be provided in the form of cords.

In another preferred embodiment of the hose according to the invention, the textile reinforcement can be provided in a single layer, embedded within the elastomer material. In this case, the textile reinforcement is provided between an inner layer of an elastomer material and an outer layer of an elastomer material; i.e., the hose according to the invention in this preferred embodiment has an inner tube composed of elastomer material, the textile reinforcement is located above this inner tube, while the outer tube is located above this textile reinforcement, the outer tube being composed of the identical elastomer material as the inner tube. Elastomer material is preferably also provided between the fibers of the textile reinforcement.

The fibers of the textile reinforcement can also be treated with an adhesion promoter, by way of example, with an organic polyisocyanate solution. If the fibers of the textile reinforcement are treated with an adhesion promoter, the fibers may also have a hot-air shrinkage before treatment that is greater than 2.5%, provided that after being treated with the adhesion promoter the fibers exhibit the required hot-air shrinkage according to the invention of less than 2.5%. Preferably, the fibers of the textile reinforcement have the required hot-air shrinkage according to the invention of less than 2.5% even before being treated with the adhesion promoter. What is especially preferred is that the hose according to the invention be characterized in that the fibers of the textile reinforcement are untreated, i.e., are free of adhesion promoters.

The textile reinforcement may also be provided in the form of braided fabrics, or in the form of fibers that are wound in spiral fashion around the inner hose tube. The textile reinforcement is preferably provided in the form of woven fabric, in particular, circular woven fabric, knitted fabrics, in particular, circular knitted fabrics, or in the form of crocheted fabrics, in particular, circular crocheted fabrics.

The textile reinforcement provides high burst strength and reduces any noticeable elongation of the hose under high pressure. At the same time, the textile reinforcement ensures that the hose is able to resist collapsing when a vacuum is present.

The hose according to this invention, is suited especially for handling hot fluids, specifically, water-based fluids or water-based solutions. The invention is therefore especially well-suited for use as a radiator coolant hose. A radiator coolant hose according to this invention exhibits improved resistance to hydrolysis.

The invention also comprises a method for producing a hose that comprises a textile reinforcement. This method includes the steps: extruding a hose composed of an elastomer material, applying a textile reinforcement to the outer circumference of the extruded hose, wherein the textile reinforcement is essentially composed of fibers that are selected from the group of aliphatic polyamides, extruding a covering composed of an elastomer material onto the textile reinforcement, and subsequently vulcanizing the hose thus obtained, characterized in that fibers are selected for the textile reinforcement that have a hot-air shrinkage less than 2.5%, preferably less than 2.3%, especially preferably less than 2.1%, where the hot-air shrinkage is determined according to DIN 53866 at 180° C., 2 min, and a preload of 5 mN/tex.

To effect vulcanization, the hose is mounted on a curing mandrel, thereby causing the resulting hose to take on a shape matching the shape of the curing mandrel. The vulcanization can be implemented, for example, in saturated steam in an autoclave. The finished hose preferably has a bent section or a bend over its length.

In a preferred embodiment of the method according to the invention, the fibers of the textile reinforcement are not treated with an adhesion promoter. The fibers of the textile reinforcement are therefore preferably free of adhesion promoters.

1. Hose, comprising an elastomer material and a textile reinforcement, wherein the textile reinforcement is composed essentially of fibers selected from the group of aliphatic polyamides, characterized in that the hot-air shrinkage of the utilized fibers is less than 2.5%, as determined by DIN 53866 at 180° C., 2 min, and a preload of 5 mN/tex.

2. Hose according to claim 1, characterized in that the hot-air shrinkage of the fibers is less than 2.3%.

3. Hose according to claim 1 or 2, characterized in that the hot-air shrinkage of the fibers is less than 2.1%.4

4. Hose according to one or more of claims 1 through 3, characterized in that the fibers of the textile reinforcement are treated with adhesion promoters, and that before treatment with the adhesion promoters the fibers have a hot-air shrinkage as indicated in claims 1 through 3.

5. Hose according to one or more of claims 1 through 3, characterized in that the fibers of the textile reinforcement are free of adhesion promoters.

6. Use of a hose according to one or more of claims 1 through 5 as a radiator coolant hose.

7. Method for producing a hose comprising a textile reinforcement, including the steps: extrusion of a hose from an elastomer material, applying the textile reinforcement to the outer circumference of the extruded hose, wherein the textile reinforcement is composed essentially of fibers that are selected from the group of aliphatic polyamides, extruding a covering composed of an elastomer material onto the textile reinforcement, and subsequently vulcanizing the hose thus obtained, characterized in that fibers are selected for the textile reinforcement that have a hot-air shrinkage less than 2.5%, where the hot-air shrinkage is determined according to DIN 53866 at 180° C., 2 min, and a preload of 5 mN/tex.

8. Method according to claim 7, characterized in that fibers are selected for the textile reinforcement that have a hot-air shrinkage less than 2.3%, wherein the hot-air shrinkage is determined according to DIN 53866 at 180° C., 2 min, and a preload of 5 mN/tex.

9. Method according to claim 7 or 8, characterized in that fibers are selected for the textile reinforcement that have a hot-air shrinkage less than 2.1%, wherein the hot-air shrinkage is determined according to DIN 53866 at 180° C., 2 min, and a preload of 5 mN/tex.
